(19) United States
(12) Patent Application Publication
(10) Pub. No.: US 2016/0033629 A1
(43) Pub. Date: Feb. 4, 2016

(54) OBSTACLE DETECTION SYSTEM AND OBSTACLE DETECTION METHOD USING THE SAME

(71) Applicant: HON HAI PRECISION INDUSTRY CO., LTD., New Taipei (TW)

(72) Inventor: CHIA-CHING WU, New Taipei (TW)

(21) Appl. No.: 14/680,436

(22) Filed: Apr. 7, 2015

(30) Foreign Application Priority Data
Jul. 29, 2014 (TW) 103125878

(51) Int. Cl. G01S 13/04; G01S 7/02; G01S 13/93

(52) U.S. Cl. CPC G01S 13/04; G01S 13/931; G01S 7/02

(57) ABSTRACT

An obstacle detection system includes an electromagnetic wave emitting unit, a processing module, and an alerter. The processing module includes a storage unit, a calculating unit, a comparing unit, and a controlling unit. The storage unit is configured to store return loss values and reference values at different frequencies. The calculating unit is configured to calculate factual return loss values and the deviation values between the factual return loss values and the return loss values stored in the storage unit. The comparing unit is configured to compare the deviation values with the reference values and send a signal to the controlling unit upon determining that the deviation values are larger than the reference values. The controlling unit is configured to send a control signal to the alerter upon receiving the signal, and the alerter is configured to raise an alarm. The present disclosure further provides an obstacle detecting method.

### FIELD

The subject matter herein generally relates to an obstacle detection system, and particularly, to an obstacle detection system for a vehicle and an obstacle detection method using the same.

### BACKGROUND

In a conventional obstacle detection system, a radar that detects an obstacle within a predetermined angular range is used to detect an obstacle behind a vehicle as well as another vehicle on an adjoining traffic lane. When user reverses the vehicle, the radar can transmit an ultrasonic signal, and an echo signal can be generated when the ultrasonic signal detects an obstacle. The radar controller can receive and process the echo signal, such that the direction of the obstacle can be detected.

### BRIEF DESCRIPTION OF THE DRAWINGS

Implementations of the present technology will now be described, by way of example only, with reference to the attached figures.

FIG. 1 is a block diagram of one embodiment of an obstacle detection system.

FIG. 2 is a flow chart of an obstacle detection method using the obstacle detection system in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising” when utilized, means “including, but not necessarily limited to”; it specifically indicates open-ended inclusion or membership in the so-described combination, group, series and the like.

The present disclosure is described in relation to an obstacle detection system for detecting an obstacle behind a vehicle and an obstacle detection method using the same.

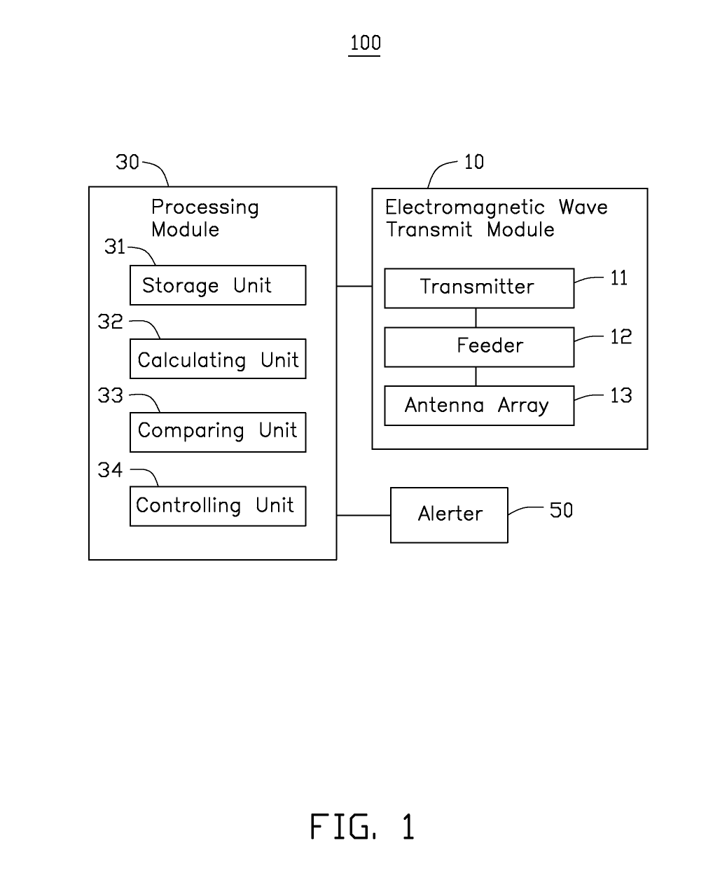

FIG. 1 illustrates that an obstacle detection system 100 includes an electromagnetic wave transmit module 10, a processing module 30, and an alerter 50. The processing module 30 can be electrically connected to the electromagnetic wave transmit module 10 and the alerter 50. The processing module 30 can be configured to detect an obstacle behind the vehicle and control the alerter 50. In at least one embodiment, the alerter 50 can be a speaker.

The electromagnetic wave transmit module 10 can include a transmitter 11, a feeder 12, and an antenna array 13. The feeder 12 can be connected between the transmitter 11 and the antenna array 13. An input terminal of the antenna array 13 can be connected to the feeder 12, and the input terminal can be a feeding point. The antenna array 13 can be fixed at the back of the vehicle (not shown). The feeder 12 can have a predetermined characteristic impedance. When an input impedance of the antenna array 13 is equal to the characteristic impedance of the feeder 12, there are only incident wave on the feeder 12, no reflected wave. When the input impedance of the antenna array 13 is not match to the characteristic impedance of the feeder 12, a part of energy can be absorbed, and the rest of the energy can be reflected to form a reflective wave. At this time, there are input wave and reflective wave in the feeder 12, and there exists return loss. When there is no obstacle around the antenna array 13, there are different return loss values corresponding to different frequencies in a frequency band of the antenna array 13 caused by a characteristic of the antenna array 13. In use, when there is an obstacle around the antenna array 13, the obstacle can change a radiation pattern of the antenna array 13, and the frequency band of the antenna array 13 can be shifted. The return loss value corresponding to each frequency can also be changed, thus the return loss values at different frequencies in the shifted frequency band can be different with the return loss values at the frequencies in the frequency band when there is no obstacles. Deviation values between the factual return loss values and the corresponding return loss values at different frequencies can be calculated. The farther the obstacle away from the array antenna 13, the smaller the deviation values.

The processing module 30 can include a storage unit 31, a calculating unit 32, a comparing unit 33, and a controlling unit 34. The return loss values and reference values corresponding to different frequencies in the frequency band of the antenna array 13 can be stored in the storage unit 31. In at least one embodiment, the reference value can be set according to a distance to be detected. The reference value can be a reference for the deviation value between the return loss value at each factual frequency of the antenna array 13 during use and the corresponding return loss value stored in the processing module 30. Each reference value corresponding to the frequency can be defined by the distance to be detected.

The calculating unit 32 can be configured to calculate the return loss values at the factual frequencies of the antenna array 13 during use, and calculate the deviation values between the factual return loss values during use and the return loss values at the corresponding frequencies stored in the storage unit 31. The calculating unit 32 can feed back the deviation values to the comparing unit 33. The comparing unit 33 can be configured to compare the deviation values with the reference values at the corresponding frequencies, and estimate if there exists the obstacle in the distance to be detected. The comparing unit 33 can feed back the estimated result to the controlling unit 34, and the controlling unit 34 can control the alerter 50 according to the estimated result. In at least one embodiment, the comparing unit 33 can be further configured to send a signal to the controlling unit 34 upon determining that the deviation values are larger than the reference values, and the controlling unit 34 can be further configured to send a control signal to the alerter 50 upon receiving the signal. In at least one embodiment, when the deviation values got by the comparing unit 33 are larger than the corresponding reference values, there exists the obstacle within the distance to be detected. The estimated result can be feed back to the controlling unit 34, and the alerter 50 can arise an alarm controlled by the controlling unit 34. In at least one embodiment, the smaller the reference value set at each frequency, the larger the distance from the antenna array 13 to be detected.

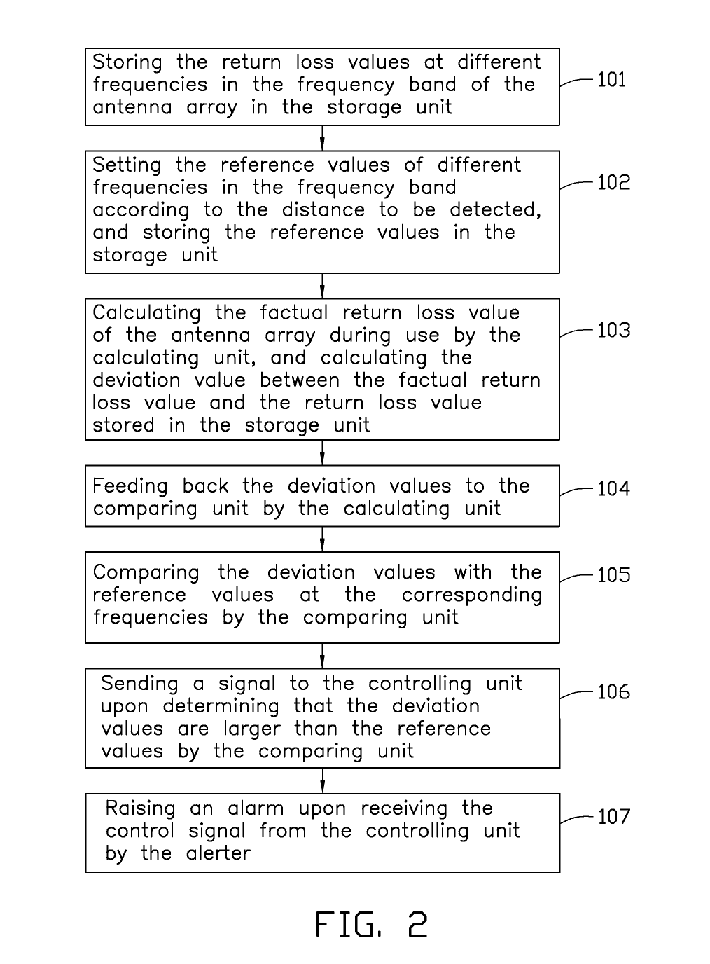

Referring to FIG. 2, a flowchart is presented in accordance with an example embodiment of an obstacle detecting method which is being thus illustrated. The example method is provided by way of example, as there are a variety of ways to carry out the method. Each block shown in FIG. 2 represents one or more processes, methods or subroutines, carried out in the example method. Furthermore, the illustrated order of blocks is by example only and the order of the blocks can change according to the present disclosure. Additional blocks may be added or fewer blocks may be utilized, without departing from this disclosure. The example method can begin at block 101.

At block 101, the return loss values at different frequencies in the frequency band of the antenna array 13 can be stored in the storage unit 31. The return loss values at different frequencies in the frequency band of the antenna array 13 is resulted by the characteristics of the antenna array 13.

At block 102, the reference values at different frequencies in the frequency band can be set according to the distance to be detected and can be stored in the storage unit 31. The reference value can be configured as a reference for the deviation value between the return loss value of the factual frequency of the antenna array 13 during use and the return loss value stored in the storage unit 31.

At block 103, the factual return loss values of the antenna array 13 during use can be calculated, and the deviation values between the factual return loss values and the corresponding return loss values stored in the storage unit 31 can be calculated by the calculating unit 32.

At block 104, the deviation values can be feed back to the comparing unit 33 by the calculating unit 32.

At block 105, the deviation values can be compared with the corresponding reference values by the comparing unit 33. When the deviation values are larger than the corresponding reference values, the comparing unit 33 determined that there is the obstacle within the distance from the antenna array 13 corresponding to the reference values. Then the process at block 106 can be executed. If not, the process at block 105 can be executed all the time.

At block 106, the signal can be sent to the controlling unit 34 upon determining that the deviations values are larger than the reference values by the comparing unit 33.

At block 107, the control signal can be sent to the alerter 50 by the controlling unit 34, and the alerter can raise the alarm upon receiving the signal.

The obstacle detecting system 100 can detect the obstacle within a distance from the antenna array 13. The radiation pattern of the antenna array 13 can be changed when there is an obstacle around the antenna array 13, so the return loss value of the antenna array 13 can be changed. The reference value is set, and the deviation value between the factual return loss value of the antenna array 13 and the return loss value stored in the storage unit 31 at the frequency can be calculated. The deviation value and the reference value can be compared, configured to estimate if there is an obstacle within the distance to the detected. As the obstacle can change the radiation pattern of the antenna array 13, there is no blind detection area. Furthermore, the smaller the reference value at each frequency, the farther the distance to the detected.

The embodiments shown and described above are only examples. Many details are often found in the art such as the other features of an obstacle detection system and an obstacle detection method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An obstacle detecting system for detecting the presence of an obstacle behind a vehicle, the obstacle detecting system comprising:
an electromagnetic wave transmit module configured to transmit electromagnetic wave;
an alerter; and
a processing module electrically connected to the electromagnetic wave transmit module and the alerter, the processing module including:
a storage unit configured to store return loss values at different frequencies in a frequency band of the electromagnetic wave transmit module, and reference values set according to a distance to be detected at different frequencies;
a calculating unit configured to calculate factual return loss values of the electromagnetic wave transmit module during use, and deviation values between the factual return loss values during use and the return loss values stored in the processing module;
a comparing unit configured to compare the deviation values with the corresponding reference values; and
a controlling unit configured to control the alerter,
wherein the comparing unit is further configured to send a signal to the controlling unit upon determining that the deviation values are larger than the reference values;
the controlling unit is further configured to send a control signal to the alerter upon receiving the signal; and
the alerter is further configured to raise an alarm upon receiving the control signal from the controlling unit.

2. The obstacle detecting system as claimed in claim 1, wherein the farther the distance to be detected, the smaller the reference values at different frequencies in the frequency band of the electromagnetic wave transmit module.

3. The obstacle detecting system as claimed in claim 1,
wherein the electromagnetic wave transmit module includes a transmitter, a feeder, and an antenna array; and
wherein the feeder is electrically connected between the transmitter and the antenna array.

4. The obstacle detecting system as claimed in claim 3,
wherein the obstacle near the array antenna changes a radiation pattern of the antenna array, thus the frequency band of the antenna array is shift; and
wherein the farther the obstacle away from the array antenna, the smaller the deviation values between the factual return loss values in the frequency band of the antenna array during use and the return loss values stored in the processing module.

5. An obstacle detecting method comprising:
supplying an obstacle detecting system, the obstacle detecting system comprising:
an electromagnetic wave transmit module configured to transmit electromagnetic wave;
an alerter; and
a processing module electrically connected to the electromagnetic wave transmit module and the alerter, the processing module including:
a storage unit configured to store return loss values at different frequencies in a frequency band of the electromagnetic wave transmit module, and reference values set according to a distance to be detected at different frequencies;
a calculating unit configured to calculate factual return loss values of the electromagnetic wave transmit module during use, and deviation values between the factual return loss values during use and the return loss values stored in the processing module;
a comparing unit configured to compare the deviation values with the corresponding reference values; and
a controlling unit configured to control the alerter;
storing the return loss values at different frequencies in the frequency band of the electromagnetic wave transmit module in the storage unit;
storing the reference values at different frequencies according to the distance to be detected in the storage unit;
calculating the factual return loss values of the electromagnetic wave transmit module during use, and calculating the deviation values between the factual return loss values and the return loss values stored in the storage unit by the calculating unit;
comparing the deviation values with the corresponding reference values by the comparing unit;
sending a signal to the controlling unit upon determining that the deviation values are larger than the reference values by the comparing unit;
sending a control signal to the alerter upon receiving the signal by the controlling unit; and
raising an alarm upon receiving the control signal from the controlling unit by the alerter.

6. The obstacle detecting method as claimed in claim 5, wherein the farther the distance to be detected, the smaller the reference values at different frequencies in the frequency band of the electromagnetic wave transmit module.

7. The obstacle detecting method as claimed in claim 5, wherein the method further comprises a step of feeding back the deviation values to the comparing unit by the computing unit.

8. The obstacle detecting method as claimed in claim 7, wherein the comparing unit confirms that there is an obstacle within the distance to be detected when the deviation values are larger than the reference values at the corresponding frequencies.
